(19) United States
(12) Patent Application Publication
(10) Pub. No.: US 2003/0161213 A1
(43) Pub. Date: Aug. 28, 2003

(54) Blender for mixing particulate solid materials including an internal baffle

(76) Inventor: Clive Eric Davies, Waikanae (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/258,038

(22) PCT Filed: Apr. 20, 2001
(86) PCT No.: PCT/NZ01/00066

(30) Foreign Application Priority Data
Apr. 23, 2000 (NZ) 502031

(51) Int. Cl. B01F 9/06

(52) U.S. Cl. 366/228

(57) ABSTRACT

A bin blender for mixing particulate solid materials, comprises a closable bin for containing the materials and having a non-circular cross-sectional shape, means mounting the bin for rotation of the bin about an axis extending across the interior of the bin, and an internal baffle extending within the bin at an angle of less than about 45° to the axis of rotation of the bin.

### FIELD OF INVENTION

The invention relates to bin blenders for mixing particulate solid materials.

### BACKGROUND

The bin blender, or tote blender as it is also called, is one of a family of devices for batch mixing particulate solids, in which mixing is promoted by rotating a vessel containing the solids about a fixed axis. Bin blenders usually have a square cross-section, constant in the upper part of the bin, and reducing uniformly to a discharge point at the lower end. The axis of rotation is fixed at an angle of typically about 15 degrees to a diagonal drawn between opposite corners of a cross-section through the bin. Bin blenders are an attractive option for many processes, because the blending vessel can also be used for storing and transporting the particles, while keeping them in a controlled environment.

The purpose of a blender is to produce a uniform mixture of two or more different components, which are placed in the blender in fixed proportions to each other, so that, after the blender has been operated, samples taken from the mixture contain the different components in proportions the same as or similar to the proportions of the components placed in the blender. In many industrial applications, the mixture made in the blender is removed from the blender, and then divided into batches. If the components in the blender are not intimately and uniformly mixed, then the proportions of the components in the different batches can differ from batch to batch. Also, the proportions of the components in a batch can differ from the proportions of the components placed in the blender. For most mixing operations, if the proportions of the components in samples taken from the mixture are sufficiently close to the proportions of the components placed in the blender, then the mixing operation is thought of as satisfactory. The extent to which the proportions of the components must be similar to the proportions of the components placed in the blender, or the limits of the composition of the mixture are often given in specifications relating to the particular mixture and mixing operation.

### SUMMARY OF INVENTION

In broad terms in one aspect the invention comprises a bin blender for mixing particulate solid materials comprising a closable bin for containing the materials and having a non-circular cross-sectional shape, means mounting the bin for rotation of the bin about an axis extending across the interior of the bin, and an internal baffle within the bin having a height dimension, and a depth dimension of the baffle across the interior of the bin and generally towards or through a center region of the bin.

Preferably the axis of rotation of the bin extends across the interior of the bin at an angle of less than about 45° to a diagonal across the bin between two opposite corners of the bin. Preferably the axis of rotation of the bin extends across the interior of the bin at an acute angle of less than about 30° to the diagonal across the bin.

Preferably the baffle member extends at an angle of less than about 45° to the axis of rotation of the bin. Preferably the baffle member extends at an angle of less than about 30° to the axis of rotation of the bin. Preferably the baffle extends at an acute angle to the axis of rotation of the bin.

Preferably the baffle extends in a depth dimension of the baffle from at or near one corner or side of the bin part way across the interior of the bin towards another corner or side of the bin. Preferably the depth dimension of the baffle member across the interior of the bin is between about one third and two thirds of the dimension across the interior of the bin in the plane of the baffle member. Preferably the height dimension of the baffle member is less than the full height of the interior of the bin but is at least half of the full height of a substantially constant cross-section part of the interior of the bin.

It has been found that it can be difficult to operate a bin blender in a way that produces a satisfactory mixture. More particularly, it can be necessary to rotate a bin blender a very large number of times to achieve good mixing. This can cause breakage of the materials being blended, and is also time consuming. With the blender of the invention the number of times that a bin blender must be rotated so that the proportions of the components in samples taken from the mixture, are sufficiently close to the proportions of the components placed in the blender, that the composition of the mixture is within specification and the mixing operation is considered to be satisfactory, is reduced.

### BRIEF DESCRIPTION OF THE DRAWINGS

The invention is further described with reference to the accompanying drawings, by way of example and without intending to be limiting. In the drawings:

FIG. 1 is a longitudinal cross-sectional view through the bin of a conventional bin blender,

FIG. 2 is a transverse cross-section view of the bin of FIG. 1 along line A-A of FIG. 1,

FIG. 3 is a longitudinal cross-section view similar to FIG. 1 through a bin incorporating one form of internal baffle in accordance with the invention,

FIG. 4 is a transverse cross-section view similar to FIG. 2, of the preferred form bin of the invention of FIG. 3,

FIG. 5 is a longitudinal cross-section view similar to FIG. 1 through a bin incorporating another form of internal baffle in accordance with the invention,

FIG. 6 is a transverse cross-section view similar to FIG. 2 of the preferred form bin of the invention of FIG. 5,

FIG. 7 is a longitudinal cross-section view similar to FIG. 1 through a bin incorporating a further form of internal baffle in accordance with the invention,

FIG. 8 is a transverse cross-section view similar to FIG. 2, of the preferred form bin of the invention of FIG. 7.

FIG. 9 is a transverse cross-section view similar to FIG. 2, of the preferred form bin of the invention of FIG. 3,

FIG. 10 is a transverse cross-section view similar to FIG. 2 of another preferred form of bin of the invention.

FIGS. 11 and 12 are transverse and longitudinal cross-sectional views which are referred to further in the experimental work described subsequently,

FIGS. 13 and 14 are reproductions of photographs referred to further in the experimental work described subsequently illustrating the degree of mixing achieved in a conventional blender and a blender of the invention,

FIGS. 15 and 17 are transverse cross-sectional views of bin blenders incorporating a baffle outside of the scope of the invention, and in accordance with the invention respectively, and

FIGS. 16 and 18 are reproductions of photographs referred to further in the experimental work described subsequently illustrating the degree of mixing achieved in the bin blenders of FIGS. 15 and 17.

### DETAILED DESCRIPTION OF PREFERRED FORM

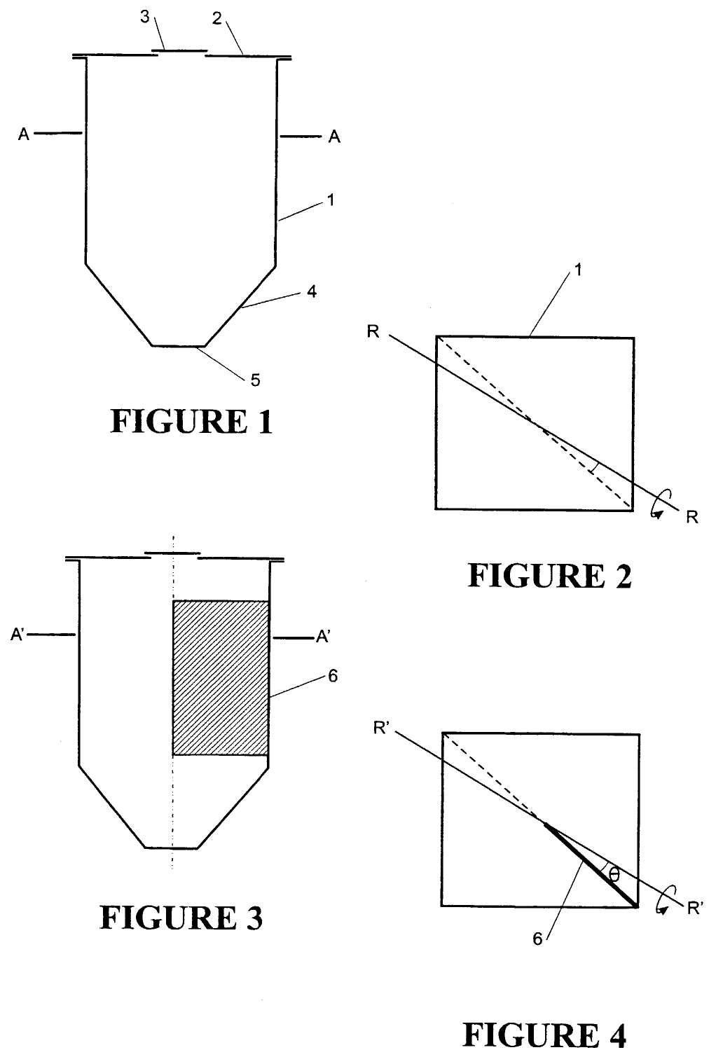

Referring to FIG. 1 a conventional bin blender comprises a bin typically having a square or rectangular shape in transverse cross-section, formed by side walls 1. The bin has a roof 2 including a door 3 for loading particulate materials to be blended into the bin, and a lower section 4 which has an inverted pyramidal shape and tapers towards an outlet 5 from which the blended materials may be dispensed in use in a manufacturing process or for packaging or similar. The bin may alternatively have a circular or any other shape in cross-section with a conical lower section, and need not be of a constant cross-sectional shape between the bin side walls.

In use dry particulate solids are loaded into the interior of the bin through door 3, and the bin is then closed and rotated through 360 degrees a number of times about an axis extending asymmetrically (or symmetrically) across the interior of the bin, such as asymmetric axis R-R indicated in FIG. 2 until the contents are considered to be sufficiently blended. The bin is then brought back to its starting position and the contents are emptied into a product stream in a manufacturing process or to a packaging stage if the blended materials form an end product such as a particulate laundry detergent for example. Typically a bin blending system comprises a number of individual bins as described forming a bin chain, which are conveyed from a bulk supply of the two or more materials to be blended to an input point for the materials in a manufacturing process or packaging stage, so that the bin chain provides a continuous supply of the blended particulate materials.

Referring to FIGS. 3 to 8, in accordance with the invention the bin includes an internal baffle 6 of a particular form. The baffle may be formed by a planar member like a plate.

In the form of FIGS. 3 and 4 the baffle 6 extends within the bin generally in line with the longitudinal axis of the bin and for over half the height of the bin, and from a corner of the bin to which the baffle is attached at one longitudinal edge, to about the center of the bin as shown. In this form the opposite longitudinal edge of the baffle is generally in alignment with a central axis of the bin. The depth of the baffle across the bin is approximately half the diagonal diameter of the interior of the bin between opposite corners of the bin. The baffle is less than the full height of the interior of the bin, but more than half of the height of the interior of the bin.

In the preferred form shown in the drawings, the bin has a square transverse cross-section as shown, and the axis of rotation R′-R′ shown in FIG. 4 about which the bin is rotated during blending extends at an acute angle to a diagonal axis between opposed corners of the square (or rectangular) bin, and the baffle 6 extends in a plane between diagonally opposite corners of the bin as shown. The axis of rotation of the bin may be co-incident with such a diagonal axis but preferably extends at an acute angle θ between the baffle and the angle of rotation of up to about 45°, further preferably at an acute angle of less than about 30°.

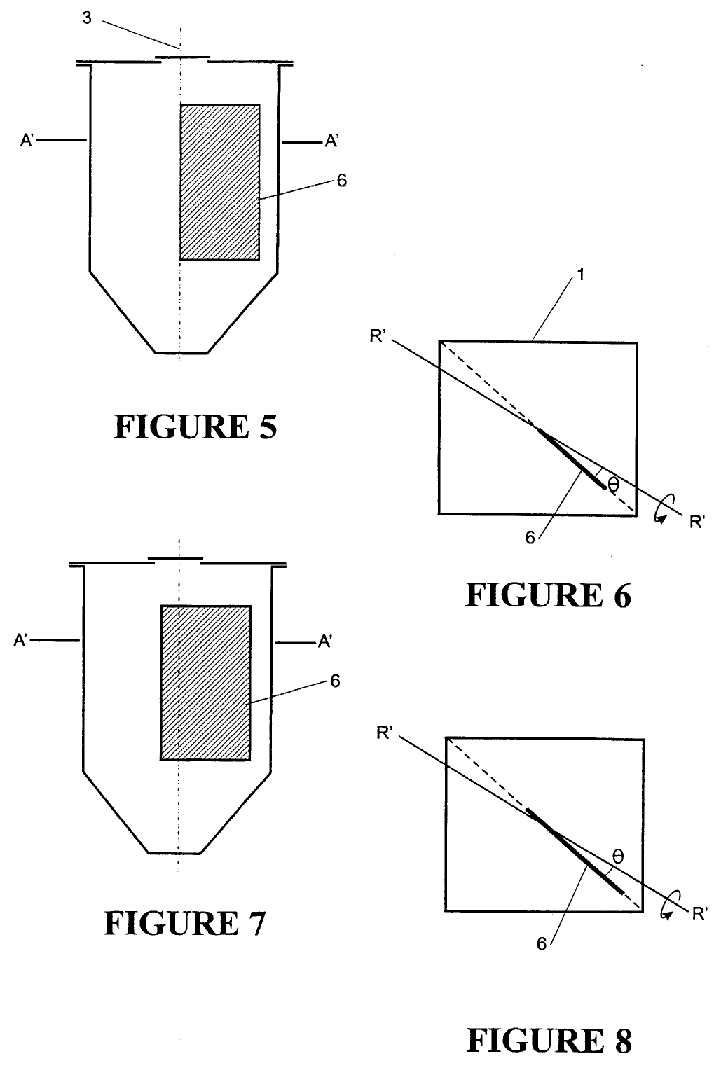

In the form of FIGS. 5 and 6 the baffle 6 extends from near one corner of the bin but the longitudinal edge of baffle adjacent the corner is spaced from the corner of the bin. In other respects the baffle is the same as in FIGS. 3 and 4. It may be preferred that the baffle not extend into a corner of the bin since this makes it harder to clean the interior of the bin when not in use.

In the form of FIGS. 7 and 8 the baffle extends from near a corner of the bin across the bin past the center of the bin, but is still asymmetrical within the interior of the bin when viewed in section across the bin and the depth dimension of the baffle is preferably not more than one half of the diameter of the bin.

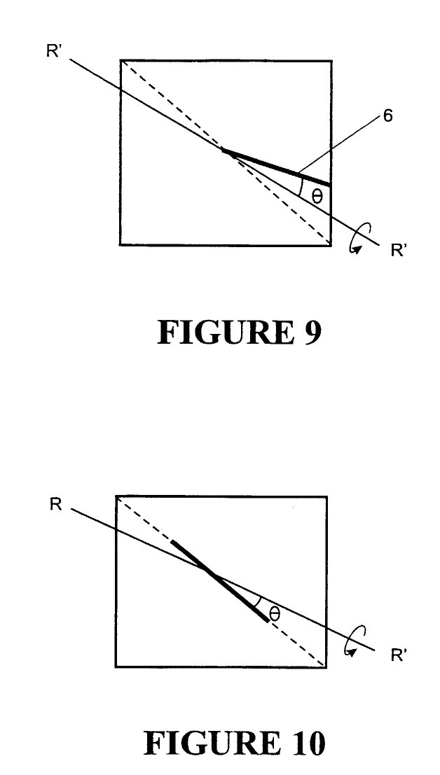

It is not essential that the baffle extend from a corner of the bin and FIG. 9 shows in cross-section another baffle which extends asymmetrically across the interior of the bin from a side wall of the bin.

FIG. 10 shows another form of bin blender of the invention in which a baffle extends across the interior of the bin through a central axis of the bin spaced from the corners of the bin at either the longitudinal edge of the baffle.

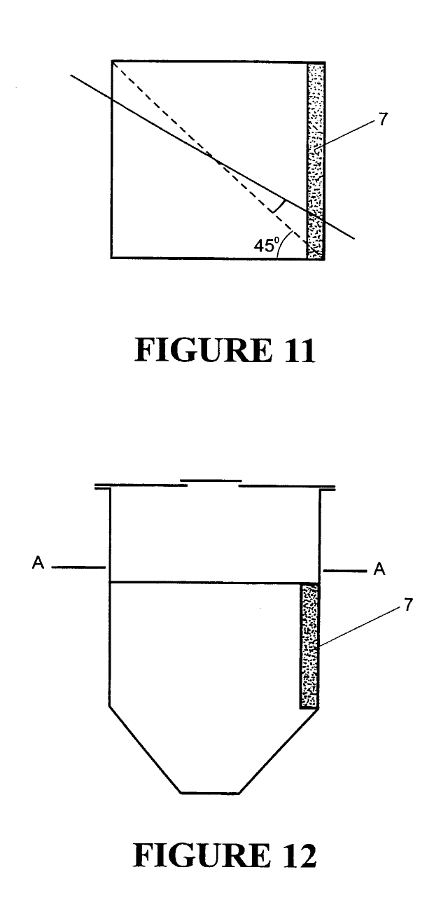

Experimental work has shown that in a bin blender incorporating a baffle of the invention, the degree of mixing or blending achieved with a set number of rotations of the bin is very substantially and surprisingly improved, or that to achieve a desired degree of blending or mixing the number of rotations required may be reduced substantially, giving a commercially significant reduction in blending time required. Experiments measuring the extent of mixing were carried out with a white powder. Some of the particles in the powder were stained with a black dye. The stained particles, which were black, could easily be seen against a background of white particles. White powder was placed in the blender so that about 70% of the volume of the blender was filled with particles, and a small quantity of the stained particles was placed in a narrow region 7 of the blender as shown in FIG. 11; a plan view of the narrow band of particles is shown in FIG. 12. Care was taken to ensure that when the black particles were placed in the blender, they were only placed in the narrow region 7.

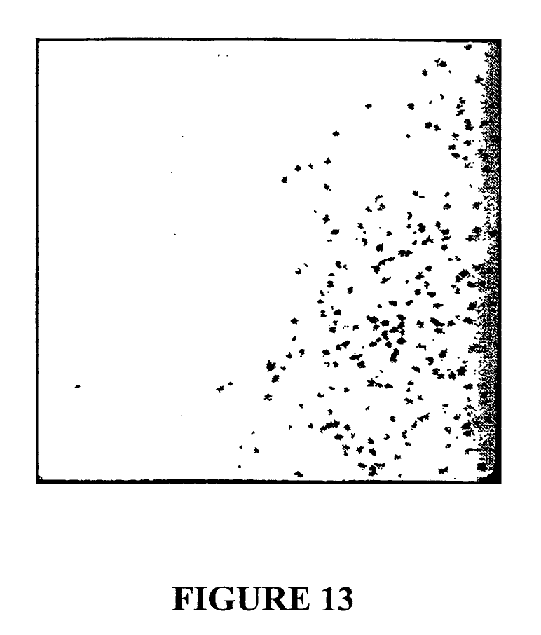

This was first of all done with the blender without an internal baffle. The blender was then rotated 20 times, at a rate of 50 revolutions per minute. The number of rotations and the speed of rotation were chosen for the purposes of this experiment, and are for example only. The powder was then removed from the blender by using a suction device to suck the powder out. The powder was sucked out a small amount at a time, and in a way that the surface of the powder exposed in the blender was flat and could easily be inspected. It could be seen that there were black particles outside the narrow region 7 where they had been placed before the blender was rotated. Photographs were taken of the surface of the powder in the blender with a digital camera, and FIG. 13 is reproduced from a typical photograph. The black dots in the photograph are the black stained particles of powder. It is clear that the black particles have spread across the blender, but have not spread to all parts of the cross section of the blender.

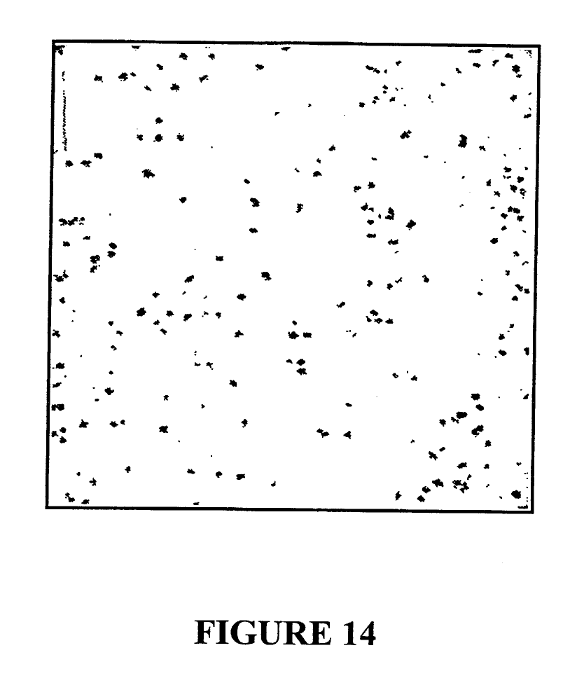

In a second experiment, the blender was fitted with a baffle as shown in FIGS. 3 and 4. White powder and a small quantity of black particles were placed in the blender according to the method of the experiments for measuring the extent of mixing. The blender was then rotated 20 times, at a rate of 50 revolutions per minute. The powder was then removed from the blender by using a suction device to suck the powder out. The powder was sucked out a small amount at a time, and in a way that the surface of the powder exposed in the blender was flat and could easily be inspected. As in the previous experiment, photographs were taken of the surface of the powder. FIG. 14 is a reproduction of a typical photograph for the experiment with the blender having a baffle according to this invention. It is clear that there are black dots spread out across the whole cross-section of the blender.

The black particles move from the narrow region, 7, because of the effects of the mixing processes in the blender, and in a mixture that is well mixed it is to be expected that the black particles will be spread out in the mixture in a uniform manner. Referring to FIG. 13, which is for a blender which was operated in accordance with this invention and to FIG. 12 which is for a blender which is not operated in accordance with this invention, it is clear that this invention improves the mixing to a very significant extent.

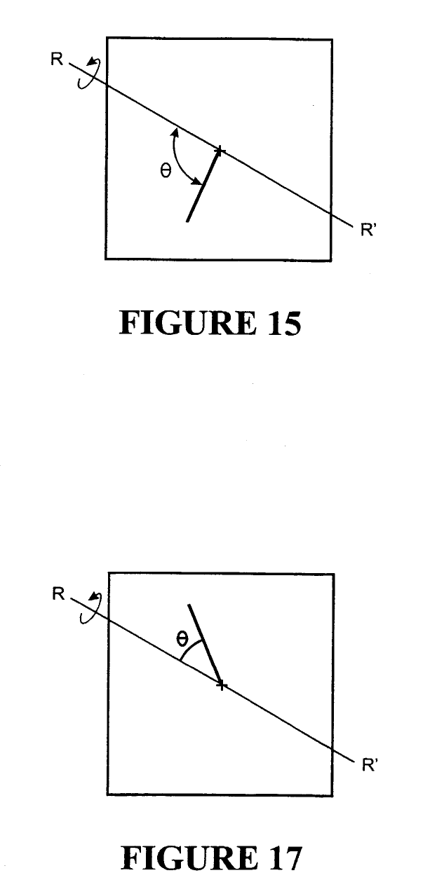

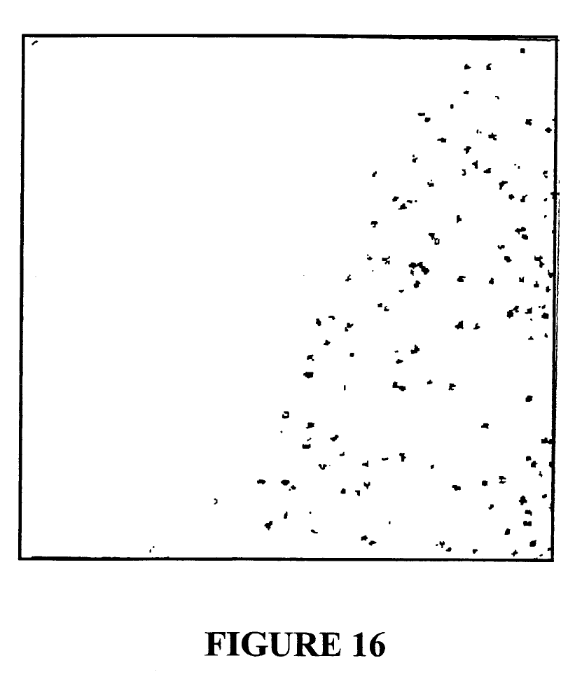

FIG. 16 is a reproduction from photographs taken of the surface of the powder in a blender after placement as described above of white powder and black tracer particles in a blender with a baffle portion shown in FIG. 15, in which blender a baffle was positioned at an angle of 97.5% to the axis of rotation of the bin (outside of the scope of the present invention). It is apparent from FIG. 16 that this baffle position achieved poor mixing.

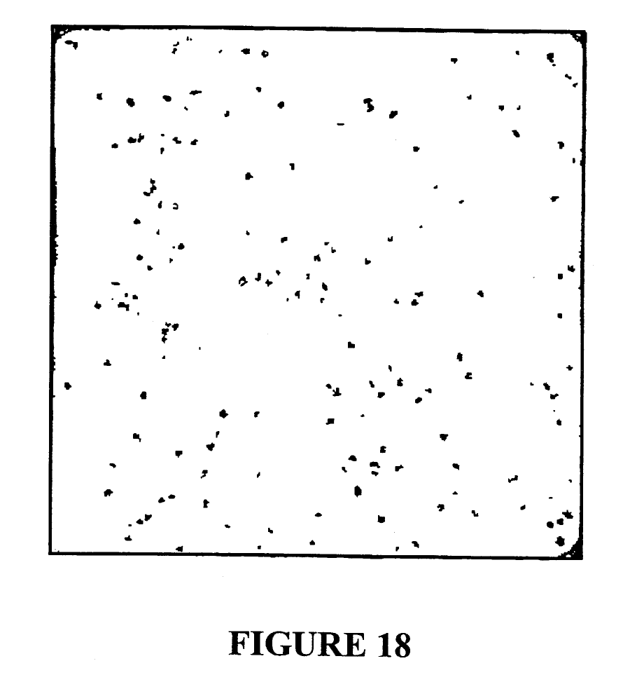

FIG. 18 shows the result of a similar experiment in which the baffle was positioned as shown in FIG. 17, at an angle of 37.5% to the axis of rotation of the bin blender, and it is clear from FIG. 18 that the black particles have spread across the blender and that good mixing has been achieved.

The foregoing describes the invention including a preferred form thereof. Alterations and modifications as will be obvious to those skilled in the art are intended to be incorporated within the scope hereof as defined in the accompanying claims.

1. A bin blender for mixing particulate solid materials, comprising a closable bin for containing the materials and having a non-circular cross-sectional shape, means mounting the bin for rotation of the bin about an axis extending across the interior of the bin, and an internal baffle within the bin having a height dimension, and a depth dimension of the baffle across the interior of the bin and generally towards or through a center region of the bin.

2. A bin blender according to claim 1 wherein the bin has four corners and the axis of rotation of the bin extends across the interior of the bin at an angle of less than about 45° to a diagonal across the bin between two opposite corners of the bin.

3. A bin blender according to claim 2 wherein the axis of rotation of the bin extends across the interior of the bin at an acute angle of less than about 30° to the diagonal across the bin.

4. A bin blender according to any one of claims 1 to 3 wherein the baffle member extends at an angle of less than about 45° to the axis of rotation of the bin

5. A bin blender according to any one of claims 1 to 3 wherein the baffle member extends at an angle of less than about 30° to the axis of rotation of the bin.

6. A bin blender according to any one of claims 1 to 5 wherein the baffle extends at an acute angle to the axis of rotation of the bin.

7. A bin blender according to claim 1 wherein the baffle extends in a depth dimension of the baffle from at or near one corner or side of the bin part way across the interior of the bin towards another corner or side of the bin.

8. A bin blender according to any one of claim 1 to 7 wherein the depth dimension of the baffle member across the interior of the bin is between about one third and two thirds of the dimension across the interior of the bin in the plane of the baffle member.

9. A bin blender according to any one of claims 1 to 8 wherein the height dimension of the baffle member is less than the full height of the interior of the bin but is at least half of the full height of a substantially constant cross-section part of the interior of the bin.

10. A bin blender according to any one of claims 1 to 9 wherein the baffle member is attached to the interior surface of a side wall of the bin at one longitudinal edge of the baffle member at or near one corner of the bin.

11. A bin blender according to any one of claims 1 to 9 wherein one longitudinal edge of the baffle member is spaced from at or near one corner of the bin.

12. A bin blender according to either one of claims 10 and 11 wherein an opposite longitudinal edge of the baffle generally coincides with a central axis of the bin.

13. A bin blender according to either one of claims 10 and 11 wherein the baffle extends across the interior of the bin past a central axis of the bin.

14. A bin blender according to any one of claims 1 to 7 wherein a central longitudinal axis of the baffle member generally coincides with a control axis of the bin.

15. A bin blender according to any one of claims 2 to 14 where the baffle is a generally planar baffle member.

16. A bin blender according to any one of claims 1 to 15 wherein the bin has a generally square or rectangular cross-sectional shape.

17. A bin blender according to any one of claim 1 to 16 where a lower part of the bin has an inverted generally pyramidal or conical shape with an outlet from the bin at its lower end.

18. A bin blender for mixing particulate solid materials, comprising a closable bin for containing the materials and having a non-circular cross-sectional shape, means mounting the bin for rotation of the bin about an axis extending across the interior of the bin, and an internal baffle within the bin extending across the interior of the bin at an angle of less than about 45° to a diagonal across the bin between two opposite corners of the bin.

19. A method for blending or mixing particulate solid materials comprising containing the particulate materials in a bin or similar closable vessel including an internal baffle an internal baffle within the bin extending in a height dimension of the baffle for over half the height of the bin and in a depth dimension of the baffle from at or near one corner or side of the bin part way across the interior of the bin towards another corner or side of the bin, and rotating the bin about an axis through the bin.
